(19) United States
(12) Patent Application Publication
(10) Pub. No.: US 2005/0021636 A1
(43) Pub. Date: Jan. 27, 2005

(54) Method, apparatus and system for configuring automated responses to email messages

(76) Inventor: Arvind Kumar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/618,480

(22) Filed: Jul. 11, 2003

(51) Int. Cl. G06F 15/16

(52) U.S. Cl. 709/206; 709/203

(57) ABSTRACT

Email users may configure a plurality of automated responses, each tailored for a different type of incoming email message. A user interface enables users to input the plurality of responses. Incoming email messages are examined and flagged according to type. Appropriate responses are then sent out automatically to the various types of emails.

### FIELD

The present invention relates to the field of electronic communications, and, more particularly, to a method, apparatus and system for enabling users to automate selective responses to electronic mail messages.

### BACKGROUND

Electronic mail (“email”) is currently one of the most popular forms of online communications. As with instant messaging and/or online chat sessions, email enables users to communicate quickly and conveniently with others on a variety of networks. Email is heavily utilized in corporate environments, to facilitate daily activities. If an email recipient is out of the office and/or otherwise unable to respond to his or her email, most email programs typically enable the recipient to configure an automatic response to incoming emails, with a pre-selected and/or customized message to inform the sender that the recipient is unable to respond.

Email programs may provide users with one or more utilities to configure these automatic responses. FIG. 1 illustrates a current utility that may be used to configure an automated response to incoming messages. More specifically, the figure illustrates a typical Out of Office Assistant (“OOOA”) setup for creating automated “Out of Office” messages in Microsoft Outlook, to automatically respond to incoming email messages. Within the OOOA, an email recipient may create additional “rules” to determine how each incoming email message is treated. For example, the recipient may set up a rule to move all incoming messages to a temporary folder for the duration that the recipient is out of the office.

### BRIEF DESCRIPTION OF THE DRAWINGS

The present invention is illustrated by way of example and not limitation in the figures of the accompanying drawings in which like references indicate similar elements, and in which:

FIG. 1 illustrates a current utility that may be used to configure an automated response to incoming email messages;

FIG. 2 illustrates a user interface according to one embodiment of the present invention;

FIG. 3 illustrates various components according to one embodiment of the present invention; and

FIG. 4 is a flow diagram illustrating the configuration and operation of one embodiment of the present invention.

### DETAILED DESCRIPTION

Embodiments of the present invention provide a method, apparatus and system for enabling email users to configure automated responses tailored to the various types of incoming email messages. Reference in the specification to “one embodiment” or “an embodiment” of the present invention means that a particular feature, structure or characteristic described in connection with the embodiment is included in at least one embodiment of the present invention. Thus, the phrases “in one embodiment”, “according to one embodiment” or the like appearing in various places throughout the specification are not necessarily all referring to the same embodiment.

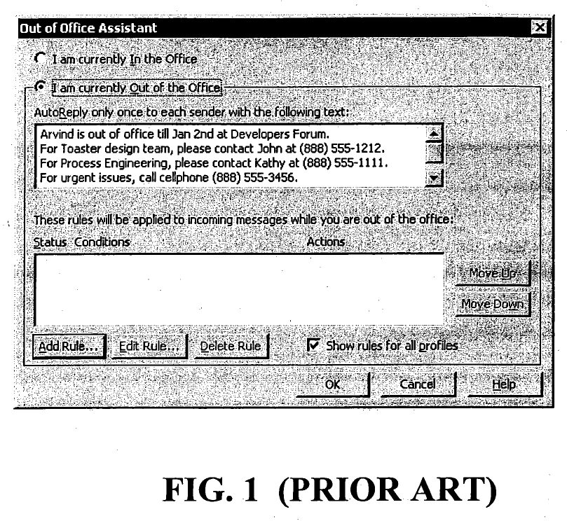

Typically, an email user may only configure their email program with a single automated response to handle all incoming email. In other words, if the user desires to set up an automated response, the same response will be sent out to every single email message received in the user's email box during a predefined period and/or until the automated response is disabled. Although seemingly innocuous, this behavior significantly limits a user's ability to communicate meaningful information in the automated response. For example, in a corporate environment, if Employee A goes on vacation, responsibility for certain of his projects may be temporarily reassigned to other employees. Employee A may efficiently communicate this information via an automated email response, to inform others who may require assistance on those projects during his absence. This type of a message is illustrated in FIG. 1, wherein the automated response provides specific contact information and phone numbers for people temporarily responsible for various projects.

Unfortunately, however, since email programs currently allow Employee A to set up only a single response, this automated response will be sent out indiscriminately to all incoming email. In other words, current utilities do not typically differentiate between internal corporate email and external email and the same automated response will be used for both. In the example illustrated in FIG. 1, this limitation may pose a problem for the corporation because highly sensitive, internal corporate information may inadvertently fall into the hands of persons outside the company. Employee A may therefore be forced to create a very simple automated response, appropriate for both internal corporate recipients as well as external recipients. This type of a limited response, however, restricts Employee A's ability to ensure that anyone within the corporation who emails him during his absence receives useful and substantive information.

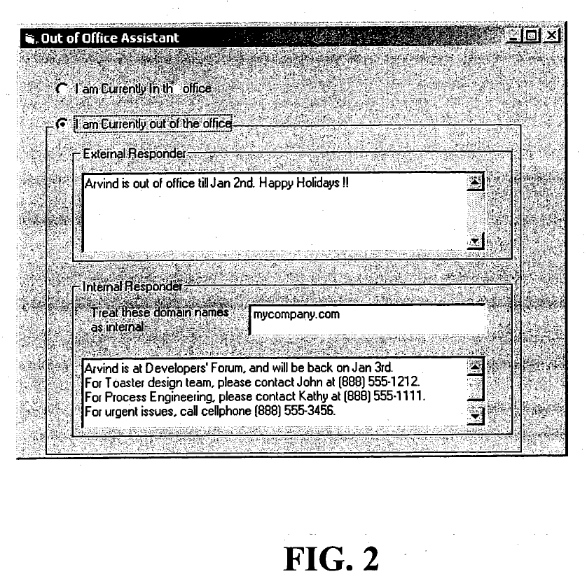

An embodiment of the present invention enables email users to configure automated responses tailored to the recipient. Specifically, in an embodiment, the email user may specify different automated responses for different types of email. Thus, in the example of Employee A above, one automated responses may be configured for all internal corporate recipients, while a different automated message may be used for external recipients. An example of such a configuration in a Microsoft Outlook environment is illustrated in FIG. 2. Although various descriptions below use Microsoft Outlook as an example email program, it will be readily apparent to those of ordinary skill in the art that embodiments of the invention are not so limited. Instead, various embodiments may be implemented in any email program capable of enabling users to configure automated responses.

Additionally, although FIG. 2 only illustrates the ability to configure two automated messages, it will be readily apparent to those of ordinary skill in the art that embodiments of the invention may easily be extended to include multiple automated responses. In one embodiment, internal and/or external recipients may be further divided into different types. For example, if Employee A is heavily involved with a standards body such as the Internet Engineering Task Force (“IETF”), Employee A may compose an additional automated response specifically directed to those emails received from the domain “ietf.org”. Thus, incoming emails may be flagged according to internal (intercom) and ietf.org, and all emails not classified as either may simply be flagged “External.” Appropriately tailored responses may then be sent out automatically for each type of incoming email.

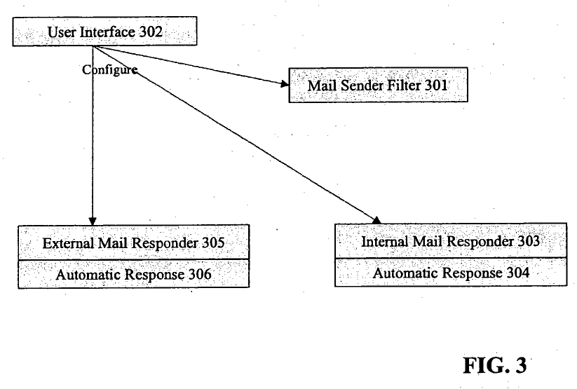

In an embodiment of the invention implemented in Microsoft Outlook, various components may be modified to enable configurable automated responses. These components are illustrated conceptually in FIG. 3. Specifically, Mail Sender Filter 301 may be modified to scan an email sender's email address and to flag the email addresses according to type (e.g., internal, external, etc.). In a corporate environment, Mail Send Filter 301 may be modified by the corporate information technology group.

User Interface 302 provides users with a simple interface by which users may configure their automated email responses. In one embodiment, various email response components may be configured to handle flagged emails (i.e., emails flagged by Mail Send Filter 301). Thus, for example, Internal Mail Responder 303 may be configured to send Automatic Response 304 to emails that are flagged “Internal.” Automatic Response 304 may include significant amounts of sensitive information, without fear of such information being disseminated outside the corporation. Although Internal Mail Responder 303 is illustrated as a single component, it will be readily apparent to those of ordinary skill in the art that multiple Internal Mail Responder 303s may in fact be configured, each capable of responding with a different Automatic Response 304 to different types of “Internal” emails. In one embodiment, for example, emails from a particular organization within a corporation may be configured to receive a first Automatic Responses 304 while another organization may be configured to receive a different Automatic Responses 304. It will be readily apparent to those of ordinary skill in the art that these internal organizations may be easily identified according to a variety of ways, including email extensions, network sub-domains and/or by automatically interrogating the corporate address book to identify a sender by the sender's organization within the corporation or by the sender's home email server.

Similarly, External Mail Responder 305 may send Automatic Response 306 to emails that are flagged “External” where Automatic Response 306 includes minimal information informing the sender that the recipient is out of the office. As with the Internal Mail Responder 303, it will be readily apparent to those of ordinary skill in the art, embodiments of the invention may also include additional flags and additional “External” mail responder components may be implemented to handle the additional flags. In the example above, an employee that is heavily involved in a standards body may flag emails with an “ietf.org” extension, and a specialized External Mail Responder 305 may respond to all such flagged email with information specific to the standards body.

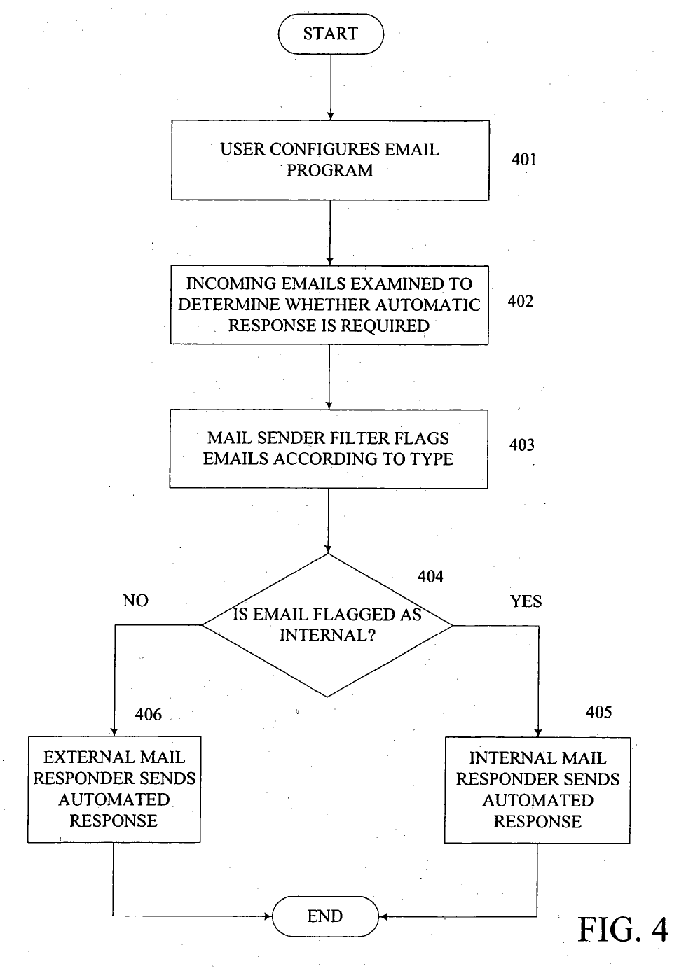

FIG. 4 is a flow diagram illustrating the configuration and operation of one embodiment of the present invention. Although the following operations may be described as a sequential process, many of the operations may in fact be performed in parallel or concurrently. In addition, the order of the operations may be re-arranged without departing from the spirit of embodiments of the invention. Specifically, in 401, a user may configure the various components of his email program (e.g., the mail sender filter, the internal mail responder and the external mail responder). Upon receipt of an incoming email message, the recipient's email configuration may be examined to determine whether an automatic response is warranted in 402. If the automatic response feature is turned on, then in 403, the mail send filter may examine and flag the email message according to type.

In one embodiment, if the email message is flagged as “Internal” email in 404, then the internal mail responder may send out an automated response in 405. If, however, the email message is not flagged as “Internal” in 404, then the external mail responder may respond in 406. It will be readily apparent to those of ordinary skill in the art that although the above description assumes only one internal and one external mail responder, an embodiment of the present invention may include multiple internal and/or external mail responders. Each mail responder may be customized to handle the automatic response for a specific type of flag. Thus, for example, within the emails flagged as “Internal,” the mail sender filter may additionally flag the email according to categories within “Internal,” as configured by the user. These categories may include flags defined for organizations and/or geographic locations, and one or more internal mail responders may automatically respond to these flagged email messages. Similarly, emails flagged as “External” may be further flagged according to categories of external email, e.g., ietf.org, ieee.org, etc., and one or more external mail responders may automatically respond to this set of flagged email messages.

Embodiments of the present invention may provide email users with increased flexibility in configuring their email programs. Specifically, according to various embodiments, email users may easily and quickly configure their email programs to automatically respond to incoming email messages. By enabling users to tailor automatic responses to various types of incoming emails, embodiments of the invention may enable users to share sensitive information with a particular type of email sender while restricting information to other types of email senders. This type of flexibility may provide significant benefit to email users, especially within a corporate environment.

Embodiments of the present invention may be implemented on a variety of data processing devices. It will be readily apparent to those of ordinary skill in the art that these data processing devices may include various types of software. According to an embodiment of the present invention, the data processing devices may also include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, the invention has been described with reference to specific exemplary embodiments thereof It will, however, be appreciated that various modifications and changes may be made thereto without departing from the broader spirit and scope of embodiments of the invention, as set forth in the appended claims. The specification and drawings are, accordingly, to be regarded in an illustrative rather than a restrictive sense.

1. A method of configuring automatic responses to incoming email messages, comprising:
enabling configuration of a plurality of automatic responses, each of the plurality of automatic responses tailored for a type of the incoming email messages;
examining the incoming email messages to determine the type; and
responding to the incoming email messages with one of the plurality of automatic responses, the one of the plurality of automatic responses selected according to the type of the incoming email message.

2. The method according to claim 1 wherein examining the incoming email messages further comprises flagging the email messages according to the type.

3. The method according to claim 1 wherein the type includes a plurality of internal mail types.

4. The method according to claim 1 wherein the type includes one of an internal mail type and an external mail type.

5. The method according to claim 4 wherein the external mail type comprises at least one of a plurality of defined domains.

6. The method according to claim 4 wherein the internal mail type comprises at least one of a plurality of defined internal organizations.

7. The method according to claim 1 wherein enabling configuration of the plurality of automated responses further comprises enabling users to configure the plurality of automated responses via a user interface.

8. An article comprising a machine-accessible medium having stored thereon instructions that, when executed by a machine, cause the machine to:
enable configuration of a plurality of automatic responses, each of the plurality of automatic responses tailored for a type of the incoming email messages;
examine the incoming email messages to determine the type; and
respond to the incoming email messages with one of the plurality of automatic responses, the one of the plurality of automatic responses selected according to the type of the incoming email message.

9. The article according to claim 8 wherein the instructions that cause the machine to examine the incoming email messages further comprises instructions that cause the machine to flag the email messages according to the type.

10. The article according to claim 8 wherein the type includes a plurality of internal mail types.

11. The article according to claim 8 wherein the type includes one of an internal mail type and an external mail type.

12. The article according to claim 11 wherein the external mail type comprises at least one of a plurality of defined domains.

13. The article according to claim 11 wherein the internal mail type comprises at least one of a plurality of defined internal organizations.

14. The article according to claim 8 wherein the instructions that enable configuration of the plurality of automated responses further comprises instructions that enable users to configure the plurality of automated responses via a user interface.

15. A system for configuring automatic responses to incoming email messages, comprising:
a user interface capable of accepting input data to configure at least one of a first automatic response and a second automatic response to the incoming email messages;
a mail sender filter capable of examining the incoming email messages to determine a type of the email messages;
a first email responder capable of sending out the first automatic email response based the type of the email messages; and
a second email responder capable of sending out the second automatic email response based on the type of the email messages.

16. The system according to claim 15 wherein the mail sender filter is further capable of flagging the email messages according to the type.

17. The system according to claim 15 wherein the first mail responder includes an internal mail responder.

18. The system according to claim 15 wherein the type includes a plurality of internal mail types.

19. The system according to claim 15 wherein the second mail responder includes an external mail responder.

20. The system according to claim 15 wherein the type includes one of an internal mail type and an external mail type.

21. The system according to claim 20 wherein the external mail type comprises at least one of a plurality of defined domains.

22. The system according to claim 20 wherein the internal mail type includes at least one of a plurality of internal organizations.
